(19) United States
(12) Patent Application Publication
(10) Pub. No.: US 2026/0015193 A1
(43) Pub. Date: Jan. 15, 2026

(54) DEVICE, TRANSPORT UNIT AND METHOD FOR TRANSPORTING NON-RIGID ELEMENTS

(71) Applicant: GROB-WERKE GmbH & Co. KG, Mindelheim (DE)

(72) Inventors: Moritz GLÜCK, Polling (DE); Patrick HIERL, Altensteig (DE); Peter VOGL, Bad Worishofen (DE); Matthias HROMADA, Obergunzburg (DE); Alexander FRITZ, Roggenburg (DE); Fabian JASER, Lamerdingen (DE); Knut MARTENS, Mindelheim (DE); Johannes HERB, Buchloe (DE)

(21) Appl. No.: 19/260,971

(22) Filed: Jul. 7, 2025

(30) Foreign Application Priority Data
Jul. 10, 2024 (DE) 102024002240.6
Oct. 11, 2024 (EP) 24020312.5

(51) Int. Cl. B65H 5/10; H01M 8/00; H01M 10/04

(52) U.S. Cl. CPC B65H 5/10; H01M 8/00; H01M 10/0404; B65H 2701/1716

(57) ABSTRACT

A device, a transport unit and a method for transporting non-rigid elements for the manufacture of a battery and/or fuel cell. The device has a transport mechanism for transporting the elements from a first region to a second region, a guide plate for guiding the transport mechanism, a drive unit for moving the transport mechanism, a lifting device for coupling the drive unit and the transport mechanism, and an assembly frame. The guide plate has a plate-like main body, a closed guide contour and a through-opening; the transport mechanism is guided by the guide contour; the drive unit has a drive shaft which extends in the first direction and is axially fixedly received in the through-opening; and the lifting device couples the transport mechanism and the drive unit to each other in a torque-transmitting manner and can adjust a distance between the two in a second direction.

### CROSS-REFERENCES TO RELATED APPLICATIONS

This application claims the benefit of German Patent Application Number 10 2024 002 240.6 filed on Jul. 10, 2024 and European Patent Application Number 24 020 312.5 filed on Oct. 11, 2024, the entire disclosures of which are incorporated herein by way of reference.

### FIELD OF THE INVENTION

The present invention relates to a device, a transport unit and a method for transporting non-rigid elements, in particular for the manufacture of a battery and/or a fuel cell.

### BACKGROUND OF THE INVENTION

Various devices are known in the prior art for transporting non-rigid elements. For example, US 2024/136591 A1 describes a stacking machine for use in battery manufacturing, which provides rolling transport of layers for battery manufacturing in order to reduce abrasion, so-called “scrubbing”. For this purpose, the stacking machine has three eccentrically rotating grippers, each of which has a special hexagonal shape, every second surface of which can be used to transport the layers. The layers are held on the surfaces by negative pressure, e.g. vacuum, and are deposited or released via positive pressure.

US 2022/173427 A1 describes a device for manufacturing layered electrode bodies. The device comprises a cutting drum for negative electrodes, which cuts a single negative electrode plate to a first width, produces a negative electrode plate and transports it; a heating drum for negative electrodes, which heats the negative electrode plate; a cutting drum for positive electrodes, which cuts a single positive electrode plate to a second width, produces a positive electrode plate and transports it; a heating drum for positive electrodes, which heats the positive electrode plate; a bonding drum; a cutting drum for separators, which cuts a separator to a third width, cuts a single second separator plate and a single first separator plate of a layered body which is joined together by the bonding drum; and a laminating drum, which layers the cut, layered bodies onto a laminating station.

U.S. Pat. No. 11,575,144 B2 describes a stacking system for battery materials, which is designed to enable layered workpieces related to battery materials to be stacked continuously at high speed. The system described comprises a transport mechanism that transports the layered workpieces in a predetermined direction, a placement mechanism that places the workpieces, and a stacking mechanism that stacks the workpieces. The placement mechanism comprises a stator of a linear motor with a predetermined running rail, a plurality of linear motor movement devices provided on the stator, pick-up elements provided on the movement devices and receiving the workpieces, and a control part that controls the running of the movement devices on the stator. The pick-up elements pick up the workpieces conveyed by the transport mechanism and transport the workpieces rotatably together with the movement devices running along the running rail of the stator, and then stack the workpieces on the stacking mechanism.

U.S. Pat. No. 11,631,881 B2 describes a stacking device for battery materials that sequentially stacks layer-shaped workpieces relating to a battery material at high speed. The stacking device comprises a transport mechanism for transporting workpieces in a predetermined direction, a rotor arranged below the transport mechanism to rotate a predetermined rotation shaft, a plurality of holding sections provided on a peripheral section of the rotor to hold the workpieces, and a stacking table for stacking the workpieces thereon. The plurality of holding sections are configured to hold one surface of each of the workpieces being transported while the other surface of each of the workpieces is held by the transport mechanism, then to transport the workpieces in accordance with rotation of the rotor while turning the workpieces over, and to stack the workpieces on the stacking table with the other surface facing the stacking table.

DE 10 2022 105 399 A1 describes a cell stacking system for stacking segments of energy cells. The system has a feed device that continuously feeds the segments at a feeding speed, and at least one cell stacking device that takes the segments from the feed device and stacks them on top of each other to form stacks. The cell stacking device has at least one removal device and a depositing device, wherein the removal device is driven in a repetitive alternating movement consisting of acceleration and deceleration, and the removal device takes the segments from the feed device at the feed speed and transfers them to the depositing device in a decelerated movement or at a standstill.

It has now become apparent that there is a further need to improve a known device for transporting non-rigid elements. In particular, there is a further need to provide a device for transporting non-rigid elements which enables improved, in particular gentle, and further in particular damage-free transport and/or improved, in particular shorter cycle times, further in particular between picking up and depositing a non-rigid element.

### SUMMARY OF THE INVENTION

In view of the above, it is an object of the present invention to provide an improved device for transporting non-rigid elements, which in particular enables gentle, and further in particular damage-free transport and/or improved, in particular shorter cycle times, further in particular between picking up and depositing a non-rigid element.

This and other objects, which are mentioned in the following description or can be recognized by the skilled person, are achieved by the subject of the various embodiments described herein.

A first aspect of the invention relates to a device for transporting non-rigid elements, in particular for the manufacture of batteries and/or fuel cells. The device comprises a transport mechanism for transporting a non-rigid element from a first region to a second region, at least one guide plate for guiding the transport mechanism, a drive unit for moving the transport mechanism, and a lifting device for coupling the drive unit and the transport mechanism. The at least one guide plate has a plate-like main body, a closed guide contour provided on the plate-like main body, and a through-opening for arranging the drive unit. The transport mechanism is guided by means of the guide contour. The drive unit has at least one drive shaft which extends in a first direction and is arranged axially fixed but rotatably in the through-opening of the at least one guide plate. The lifting device couples the transport mechanism and the drive unit to each other in a torque-transmitting manner and is designed to adjust, in a second direction, a distance between the drive shaft and the transport mechanism, which distance depends on the position of the transport mechanism relative to the guide plate.

The guide plate is fixed, e.g., mounted in an assembly frame of the device and can in particular be designed as a cam disc. In particular, the device has at least two guide plates for guiding the transport mechanism, each guide plate having a plate-like main body, a closed guide contour provided on the respective plate-like main body, and a through-opening for arranging the drive unit. The guide plates are spaced apart from each other in the first direction and are arranged substantially parallel to each other and opposite each other in the assembly frame.

The transport mechanism is coupled to the drive shaft via the lifting device in a rotationally fixed manner, i.e., torque-transmitting, so that the transport mechanism is guided along the guide contour(s) when the drive shaft rotates. The lifting device is designed to adjust the distance between the axis of rotation of the drive shaft, which is arranged in particular substantially centrally with respect to the guide plate and further in particular centrally with respect to the guide contour, and the guide contour. In particular, the guide contour is not designed as a circle, i.e., the points lying on the guide contour are not all equidistant from the axis of rotation of the drive shaft and thus from the center of the guide contour. Thus, the distance between the axis of rotation of the drive shaft and the guide contour varies depending on the position. The lifting device that couples the transport mechanism and the drive shaft is thus designed to compensate for this position-dependent change in distance so that the transport mechanism is always in contact with the guide contour when the drive shaft rotates—regardless of the distance between the axis of rotation of the drive shaft and the guide contour—and thus the movement of the transport mechanism is guided along the guide contour.

The guide contour can be in the form of a recess, e.g., a groove or a channel. In this case, the transport mechanism is guided in particular on an (radially outer) inner contour. Alternatively, it is also conceivable that the guide contour is designed in the form of a projection, e.g., as a rib. In this case, the transport mechanism is guided in particular on an outer contour, whereby the transport mechanism must be actively preloaded against the outer contour, e.g., by means of preloading elements such as spring elements.

In particular, the design of the guide contour allows the device to be adapted to an intended function, in particular in an optimal manner. Thus, the contour line of the guide contour may depend on whether the first and second regions represent sections of continuous and/or discrete systems. In other words, the contour line of the guide contour can be different. For example, if the first region and the second region are sections of a continuous system, the contour line of the guide contour can be different from a contour line of the guide contour when the first region and the second region are sections of a discrete system and/or from a contour line when the first or second region is a section of a continuous system and the other region is a section of a discrete system. In addition, the guide contour depends on the speeds at which the drive shaft and thus the transport mechanism rotates and/or on a distance, in particular a maximum distance, between the drive shaft and the transport mechanism.

Thus, the guide contour has in particular a non-circular geometry or shape. Furthermore, the guide contour has a predetermined geometry that is defined depending on several factors. These factors can be, for example, a specified cycle time, a format size of the non-rigid element, a so-called synchronization distance, and/or a torque acting on the drive shaft via the transport mechanism.

The specified cycle time is defined as a predefined period of time required by the transport mechanism to completely circle the guide contour once. It can therefore be said that the specified cycle time is the time required by the transport mechanism, in particular the time it is permitted to require, to rotate once through 360° along the guide contour. The format size of the non-rigid element is determined in particular by the width of the non-rigid element to be transported, which is designed in particular as an electrode sheet and/or mono cell. The synchronization distance is in particular a distance that is required to pick up or deposit the non-rigid element while the transport mechanism, in particular a continuous system, is in motion. The continuous system has, for example, a conveyor belt that moves continuously, in particular at a constant speed. The torque exerted by the transport mechanism on the drive shaft depends on the distance between the axis of rotation of the drive shaft and the transport mechanism. In particular, the guide contour is designed such that this torque does not exceed a predetermined threshold value at a maximum distance between the axis of rotation of the drive shaft and the transport mechanism.

The above list of factors that can influence the geometry of the guide contour is only exemplary and should therefore not be considered limiting.

It can therefore also be said that the guide contour is designed in particular in such a way that it is possible to pick up or remove non-rigid elements, in particular electrode sheets and/or mono cells, at a first position, in particular within a first region, and to deposit them again at a second position, in particular within a second region. In particular, the guide contour is designed such that the transport mechanism can remove the non-rigid elements from a continuous system or place them on it while moving, in particular such that the transport mechanism is synchronized with the speed of the continuous system, i.e., adapted to the speed of the continuous system, and on the other hand is aligned essentially parallel to the continuous system for a predetermined region in order to remove the non-rigid element from the continuous system in this predetermined region or to deposit it on the continuous system.

For example, in the manufacture of mono cells for battery cells by lamination in the stacking region, the device, in particular the transport mechanism, picks up the non-rigid elements from a central conveyor belt in motion and deposits them at another location, e.g., a vacuum carriage, in a stationary position. Furthermore, the device can also be used in other types of battery cell production, such as Z-folding, and/or in processes other than battery cell production in which non-rigid elements must be transported from a first region to a second region.

Furthermore, the device has a compact design, e.g., by arranging the drive shaft in the through-opening of the guide plate, which simplifies integration of the device into a system, such as a transport unit for transporting non-rigid elements.

The device according to the invention thus enables non-rigid elements to be transported from a first region to a second region by means of the transport mechanism synchronized via the guide contour, thereby improving cycle times, in particular when transferring the non-rigid elements from a continuous system to a discrete system or vice versa, and thus improving and, in particular, increasing the output of the system.

In addition, the device is robustly designed to reduce errors and/or failures during operation.

In other words, it can be said that the device according to the invention makes it possible to gently, in particular with little damage, and in particular essentially damage-free, pick up non-rigid elements, such as electrode layers and/or mono cells for battery and/or fuel cell production, in a first region, transport them, and deposit them in a second region. The gentle transport also makes it possible to reduce the reject rate of defective electrode layers and/or mono cells, thereby further improving the output of the system. In addition, the device enables the non-rigid elements to be removed and/or deposited in a substantially position-accurate manner, which further improves the output of the system.

According to one embodiment, the transport mechanism has a transport plate and at least one guide element, wherein the transport plate has a receiving surface for receiving the non-rigid element, the at least one guide element is coupled to the transport plate in a rotationally and axially fixed manner, and the at least one guide element of the transport mechanism is guided by means of the guide contour of the at least one guide plate.

The transport plate is designed in particular as a suction and/or vacuum plate. In addition or alternatively, the transport mechanism can be adaptable to different formats and/or sizes of the non-rigid elements, for example by designing the transport plate to be interchangeable, thereby achieving greater flexibility. Furthermore, the device can be quickly and easily adapted to different formats and/or sizes of the non-rigid elements, thereby reducing the changeover time required for such adaptation and thus reducing downtime of the device. The transport mechanism can also be designed as a gripper and the transport plate can also be referred to as a gripper plate. The guide element is coupled directly or indirectly, e.g., via a carrier or support element, to the transport plate.

According to one embodiment, the at least one guide element has at least one roller which is arranged to be in contact with the guide contour of the at least one guide plate. In particular, the at least one guide element is preloaded against the guide contour. For this purpose, the guide element is actively pressed (preloaded) against the guide contour by a preloading element, such as a spring element. In the event that the guide contour is recessed and the guide element is guided on an inner contour of the guide contour, the preload is also achieved at least in part by the centrifugal force caused by the movement of the transport mechanism. If the guide contour is designed to protrude and the guide element is guided on an outer contour of the guide contour, the preload must be generated essentially completely by the preload element, e.g., a spring element, which actively presses the guide element against the guide contour. In particular, the at least one guide element has two rollers which are spaced apart from each other on the guide element in the direction of rotation or movement of the transport mechanism. This improves the positional accuracy of the transport mechanism relative to the guide plate, in particular relative to the guide contour. For example, this ensures that the transport mechanism is arranged parallel to a continuous system, at least in sections.

According to one embodiment, the transport mechanism also has a media guide means, and the receiving surface has at least one opening that is coupled to the media guide means in a fluid-conducting manner.

In particular, the media guide means is designed to guide compressed air, especially with negative pressure, and thus generate a suction effect or negative pressure at the at least one opening of the receiving surface. The non-rigid element is held on the receiving surface by the negative pressure generated in this way. In addition, the media guide means can also be used to generate excess pressure or a pressure surge at the at least one opening of the receiving surface in order to facilitate depositing of the non-rigid element, e.g. into the second region.

In particular, the receiving surface has a plurality of openings which are connected to the media guide means in a fluid-conducting manner. Furthermore, the plurality of openings are essentially evenly distributed on the receiving surface. This allows uniform negative or positive pressure distribution across the surface of the non-rigid element, thereby enabling gentle, in particular low-damage, and further in particular damage-free pick-up, gentle, in particular low-damage, and further in particular damage-free transport, and gentle, in particular low-damage, and further in particular damage-free deposition.

According to one embodiment, the lifting device has a guide element and a coupling element, wherein the guide element is coupled to the drive shaft in a rotationally and axially fixed manner and the coupling element is coupled at one end in the second direction to the transport mechanism and is guided at the other end in the second direction linearly in the guide element along or in the second direction.

The coupling element is articulated to the transport mechanism, in particular via a rotary joint, so as to be pivotable. The guide element is integrally formed in one piece with the drive shaft. Alternatively, the guide element is formed separately from the drive shaft and is connected to the drive shaft in a rotationally and axially fixed manner, e.g. by means of a press fit. The coupling element has a predetermined length and is designed in particular as a rod and/or bar. The guide element has one or more guide bushings corresponding to the coupling element for linear guidance of the rod-and/or bar-shaped coupling element in the second direction. The linear guidance of the coupling element in the guide bushings allows the variable distances between the axis of rotation of the drive shaft and the transport mechanism to be changed depending on the position of the transport mechanism along the guide contour. The guide bushings can be designed, for example, as sliding sleeves or as rolling sleeves.

According to one embodiment, the lifting device has a guide element and a coupling element, wherein the guide element is coupled to the drive shaft in a rotationally and axially fixed manner, and the coupling element is designed as an articulated linkage that is coupled at one end in the second direction to the transport mechanism and at the other end in the second direction to the guide element.

The articulated linkage is pivotably coupled to the guide element at one end, in particular by means of a rotary joint, and pivotably coupled to the transport mechanism at another end, in particular by means of a rotary joint. Furthermore, the articulated linkage has a curved shape. The guide element is integrally formed in one piece with the drive shaft. Alternatively, the guide element is formed separately from the drive shaft and is connected to the drive shaft in a rotationally and axially fixed manner, e.g., by means of a press fit and/or by means of a screw connection.

According to one embodiment, the drive unit also has a housing and a drive motor, wherein the drive shaft is at least partially accommodated in the housing and supported therein.

The drive motor is designed to drive the drive shaft at different, in particular variable speeds. For this purpose, the drive motor can be controlled accordingly and thus enables the speed of the transport mechanism to be adapted to the different speeds required during a cycle, i.e., a movement of the transport mechanism through 360° along the guide contour, such as for synchronization with the speed of the continuous system and/or a standstill in a predetermined region for picking up and/or depositing the non-rigid element at a standstill, etc.

According to one embodiment, the drive shaft has a rotary feedthrough for guiding media. According to a further embodiment, the rotary feedthrough in the drive shaft is coupled to the media guide means of the transport mechanism in a fluid-conduction manner. Alternatively, it is also conceivable to provide a rotary feedthrough separate from the drive shaft for guiding the media, in particular for guiding the media of the transport mechanism.

The rotary feedthrough thus serves to guide a medium, in particular compressed air, to the transport mechanism, where the medium is guided by means of the media guide means to the at least one opening on the receiving surface. This means that integrated means for generating compressed air can be dispensed with on the transport mechanism. This reduces the installation space required for the transport mechanism and the weight or mass compared to such transport mechanisms with integrated means for generating compressed air.

Another aspect of the invention relates to a transport unit for transporting non-rigid elements, in particular for the manufacture of batteries and/or fuel cells. The transport unit comprises a continuous system that moves continuously, in particular at a substantially constant speed, a discrete system that moves in cycles, and a device, in particular according to the invention, for transporting non-rigid elements. The device is arranged between the continuous system and the discrete system in such a way that the device picks up a non-rigid element from the continuous system and deposits it on the discrete system, or the device picks up a non-rigid element from the discrete system and deposits it on the continuous system.

The transport unit is particularly suitable for use in a battery cell production plant for transporting electrode sheets and/or mono cells. The transport unit enables non-rigid elements to be transported from a first system to a second system as gently as possible, in particular with little or no damage. The transport may in particular involve a change from a continuous system to a discrete system, or vice versa. In such a case, the device for transporting non-rigid elements is designed to enable a change from a continuous system to a discrete system, or vice versa, during the transport of the non-rigid elements, in particular electrode sheets and/or mono cells.

Another aspect of the invention relates to a method for transporting non-rigid elements, in particular for the manufacture of batteries and/or fuel cells. The method comprises the following steps, which do not necessarily have to be carried out in the order specified:
providing a device for transporting non-rigid elements, in particular a device described above and below in accordance with the invention, wherein the device has at least one transport mechanism and one drive unit,
picking up, by the transport mechanism of the device, at least one non-rigid element in a first region,
transporting the at least one non-rigid element from the first region to a second region by means of the transport mechanism of the device, and
depositing the at least one non-rigid element in the second region by the transport mechanism of the apparatus, and
moving the transport mechanism from the second region to the first region by the drive unit of the device.

For example, the device for transporting non-rigid elements performs the following processes, in particular repeatedly:
adjusting the speed of the transport mechanism, in particular the transport plate, to the speed of the continuous system in a first region in which the non-rigid element is to be removed from the continuous system by the transport mechanism;
removing a non-rigid element from the continuous system by means of the transport mechanism, in particular by generating a negative pressure, more specifically a vacuum, at the transport plate, in particular the receiving surface, in order to “hold” the non-rigid element on the transport plate;
moving the transport mechanism, in particular at a speed different from the speed of the continuous system, along the guide contour of the guide plate to a place of deposit at which the non-rigid element transported by the transport mechanism is transferred to the discrete system;
stopping the movement of the transport mechanism, in particular the transport plate, along the guide contour of the guide plate at the level of the place of deposit, and depositing the non-rigid element from the transport mechanism onto the place of deposit at a standstill, for example by relieving the negative pressure, in particular the vacuum, at the transport plate, in particular at the receiving surface, e.g. by means of a compressed air pulse, and, essentially at the same time, generating a negative pressure, in particular a vacuum, at the place of deposit in order to “hold” the non-rigid element on the deposit location;
moving the transport mechanism along the guide contour of the guide plate to the first region.

In particular, the continuous system, e.g. a conveyor belt, can generate a negative pressure, in particular a vacuum, on a surface on or at which the non-rigid elements are transported in order to “hold” the non-rigid elements on this surface during transport. This allows the non-rigid elements to be transported by the continuous system “overhead,” i.e., on a surface that faces downward, i.e., toward the floor, without falling off this surface. Such a conveyor belt can also be referred to as a vacuum belt.

The place of deposit can in particular be a transport carriage of a linear system, which has a transport plate designed as a suction plate or vacuum plate. It is also conceivable that the deposit location is designed as a stacking location for stacking several non-rigid elements, in particular several electrode sheets and/or mono cells, on top of each other.

According to one embodiment, the drive unit moves the transport mechanism in the first region with a first speed profile, between the first region and the second region with a second speed profile, in the second region with a third speed profile, and between the second region and the first region with a fourth speed profile.

The first speed profile in the first region and the third speed profile in the second region are coordinated with whether the first region or the second region corresponds to a section of the continuous system or a section of the discrete system. The second speed profile and the fourth speed profile in the intermediate regions between the first region and the second region are specifically coordinated to keep a torque acting on the drive shaft by the transport mechanism below a predetermined threshold value. Furthermore, the speed profiles in the intermediate regions can be adapted to specified total cycle times, i.e., the speeds in the intermediate regions can be selected so that a specified total cycle time is achieved for the overall movement sequence of the transport mechanism. For example, if the specified total cycle time is 650 ms, and it takes 50 ms for the non-rigid element to be removed from the continuous system with the first speed profile in the first region and 200 ms for the non-rigid element to be transferred to the discrete system with the third speed profile in the second region, the remaining 400 ms can be divided between the two intermediate regions, in particular evenly, so that the second speed profile and the fourth speed profile are selected such that a time period for transporting the non-rigid element from the first region to the second region is essentially (e.g., +/−10%) 200 ms and a transport of the transport mechanism from the second region to the first region, a so-called return lift, is also approximately 200 ms.

According to one embodiment, the first speed profile, the second speed profile, the third speed profile, and the fourth speed profile are different from each other or at least partially the same, and/or at least one of the first speed profile, the second speed profile, the third speed profile, and the fourth speed profile has a speed that is essentially zero, at least in sections.

In particular, the speed that is essentially zero occurs in the region of the discrete system, i.e., within the first speed profile or the third speed profile.

According to one embodiment, the first region is formed as a section of a continuous system and the second region is formed as a section of a discrete system, or the first region is formed as a section of a discrete system and the second region is formed as a section of a continuous system.

According to one embodiment, when the first region is formed as the section of the continuous system and the second region is formed as the section of the discrete system, the first speed profile includes a speed that is substantially equal to a speed of the continuous system, and the third speed profile includes a speed that is substantially zero, or, when the first region is formed as the section of the discrete system and the second region is formed as the section of the continuous system, the first speed profile includes a speed that is substantially zero and the third speed profile includes a speed that substantially corresponds to a speed of the continuous system.

### BRIEF DESCRIPTION OF THE DRAWINGS

Further measures improving the invention are explained in more detail below by the description of preferred embodiments of the invention with reference to the Figures.

FIG. 1 shows an exemplary partial representation of a device for transporting non-rigid elements according to one embodiment of the invention in a perspective view.

FIG. 2 shows an exemplary partial representation of a device for transporting non-rigid elements according to one embodiment of the invention in a side view.

FIG. 3 shows an exemplary partial representation of a device for transporting non-rigid elements according to one embodiment of the invention in a side view.

FIG. 4 shows a sectional view of the exemplary partial representation of the device for transporting non-rigid elements according to one embodiment of the invention shown in FIG. 3.

FIG. 5 shows an exemplary partial representation of a device for transporting non-rigid elements according to one embodiment of the invention in a side view.

FIG. 6 shows an exemplary partial representation of a device for transporting non-rigid elements according to one embodiment of the invention in a longitudinal sectional view.

FIG. 7 shows an exemplary lift guide of a device for transporting non-rigid elements according to one embodiment of the invention in a sectional view.

FIG. 8 shows an exemplary lift guide of a device for transporting non-rigid elements according to one embodiment of the invention in a sectional view.

FIG. 9 shows an exemplary partial representation of a device for transporting non-rigid elements according to one embodiment of the invention in a perspective view.

FIG. 10 shows an exemplary lift guide of a device for transporting non-rigid elements according to one embodiment of the invention in a front view.

FIG. 11a shows an exemplary guide plate of a device for transporting non-rigid elements according to one embodiment of the invention in a front view.

FIG. 11b shows an exemplary guide plate of a device for transporting non-rigid elements according to one embodiment of the invention in a perspective view from behind.

FIG. 12 shows an exemplary transport unit according to one embodiment of the invention.

FIG. 13 shows a flow chart of an exemplary movement sequence of a device for transporting non-rigid elements according to one embodiment of the invention.

FIG. 14 shows a flow chart of an exemplary method for transporting non-rigid elements according to one embodiment of the invention.

FIG. 15 shows a flow chart of an exemplary process for manufacturing a battery cell by lamination.

The Figures are merely schematic and serve only to illustrate the invention. Same or similar elements are designated by same or similar reference signs.

### DETAILED DESCRIPTION OF THE PREFERRED EMBODIMENTS

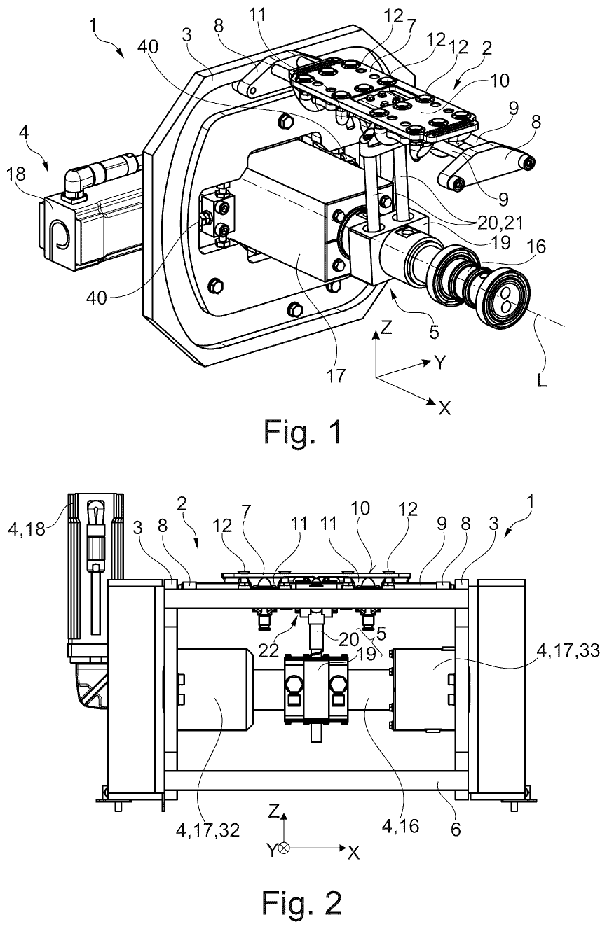

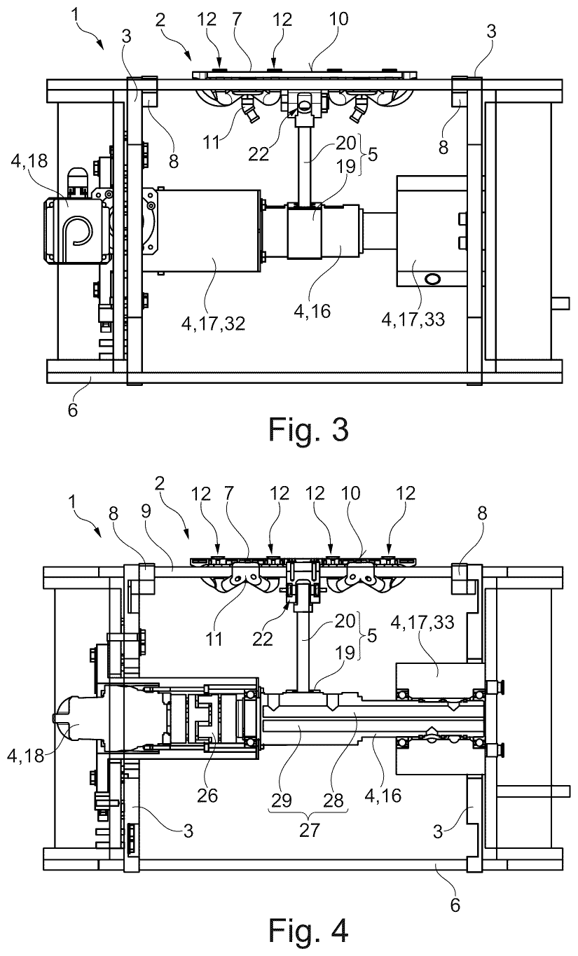

FIGS. 1 to 3 show schematic and exemplary partial representations of a device 1 for transporting non-rigid elements 48 (see FIG. 12) according to an exemplary embodiment of the invention. The device 1 comprises a transport mechanism 2, two guide plates 3 (only one guide plate is shown in FIG. 1), a drive unit 4, a lifting device 5, and an assembly frame 6 (not shown in FIG. 1).

The transport mechanism 2 is for transporting a non-rigid element 48 from a first region A to a second region B (see FIG. 12). The transport mechanism 2 has a transport plate 7 and two guide elements 8. The transport plate 7 has a receiving surface 10 for receiving the non-rigid element 48 (see FIG. 12) and is shown here, for example, fixedly arranged on two support elements 9, wherein the two support elements 9 are connected at both ends in a first direction X to a respective guide element 8. Furthermore, the transport mechanism 2 has a media guide means 11 for guiding gas and/or fluids, in particular pressurized air, and the receiving surface 10 has several through openings 12. The gas and/or fluid is supplied to the media guide means 11 from outside the device 1. Channels or conduits of the media guide means 11 are coupled to the through openings 12 of the receiving surface 10, whereby, for example, by generating a negative pressure or vacuum at the openings 12, the non-rigid element 48 can be held on the receiving surface 10. By generating positive pressure, e.g., a pressure surge, at the openings 12, the non-rigid element can be released from the receiving surface 10. The media guide means 11 and the transport plate 7 can be formed integrally in one piece, e.g. by means of 3D printing.

Each guide plate 3 serves to guide the transport mechanism 2 and has a disc-like or plate-like main body 13, a self-contained guide contour 14, and a through opening 15. The guide contour 14 is exemplarily designed here as a groove-or slot-like recess in the main body 13, into which the guide elements 8 of the transport mechanism 2 engage in such a way that movement of the transport mechanism 2 is guided by the guide elements 8 being in contact with the guide contour 14, in particular are pressed at least slightly against it, and the guide elements 8 and thus the transport mechanism 2 move along the guide contour 14. The guide contour 14 has a predetermined, in particular non-circular contour. The predetermined contour is defined depending on various factors, such as a specified cycle time, a format size of the non-rigid element 48, a so-called synchronization distance, and/or a torque acting on the drive shaft 16 via the transport mechanism 2. In the exemplary embodiment shown in FIGS. 1 to 3, the two guide plates 3 are spaced apart from each other in the first direction X, with the respective guide contours 14 facing each other so that the transport mechanism 2 is guided at both ends in the first direction X by a guide element 8 in each guide contour 14. The guide contours 14 of the two guide plates 3 are thus matched to each other in such a way that they are congruent when they are arranged facing each other.

The drive unit 4 serves to move the transport mechanism 2 and has a drive shaft 16, a housing 17 in which the drive shaft 16 is at least partially accommodated, and a drive motor 18. The drive motor 18 is designed to rotate the drive shaft 16, whereby the rotational speed of the drive shaft 16 can be controlled, i.e., varied, by corresponding control of the drive motor 18. The drive unit 4 is arranged here, for example, such that a rotational axis L of the drive shaft 16 extends in the first direction X and the drive shaft 16 is received at its ends in the first direction X in the through-openings 15 of the guide plates 3. It can also be said that the drive shaft 16 extends between the guide plates 3 in the first direction X and is mounted directly or indirectly in the through-openings 15 of the guide plates 3.

The lifting device 5 serves to couple the drive unit 4, in particular the drive shaft 16, and the transport mechanism 2 in a torque-transmitting manner. The lifting device 5 has a lift guide element 19 and a coupling element 20. The lift guide element 19 is coupled to the drive shaft 16 in such a way that it cannot rotate or move axially, and the coupling element 20 couples the transport mechanism 2 to the lift guide element 19 in such a way that the distance between the axis of rotation L of the drive shaft 16 and the transport mechanism 2 varies depending on the position. It can also be said that the transport mechanism 2 rotates together with the drive shaft 16 and thereby moves along the guide contour 14. The lifting device 5 compensates for the distance between the axis of rotation L and the transport mechanism 2, which varies depending on the position of the transport mechanism 2 along the guide contour 14. The transport mechanism 2 is thus guided along the guide contour 14 by the rotation of the drive shaft 16, whereby the rotational speed of the drive shaft, and thus the circumferential speed of the transport mechanism 2, can be controlled or regulated by corresponding control of the drive motor 18. In particular, the rotational speed of the drive shaft 16 depends on the position of the transport mechanism 2 along the guide contour 14, since the transport mechanism 2 can be moved at different speeds in different regions along the guide contour 14.

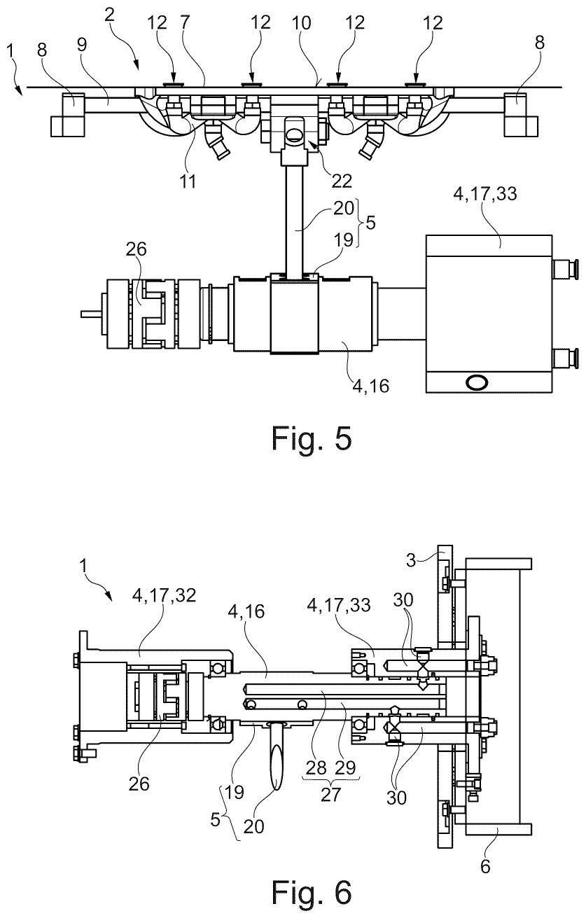

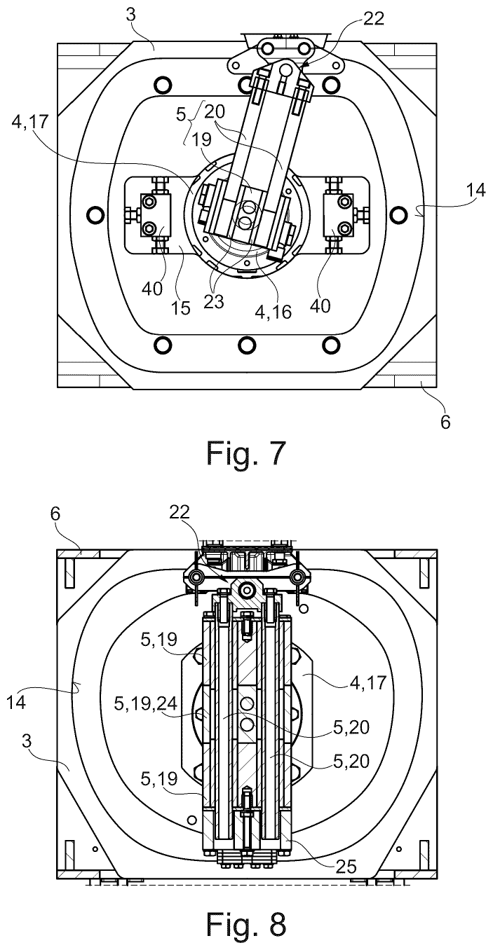

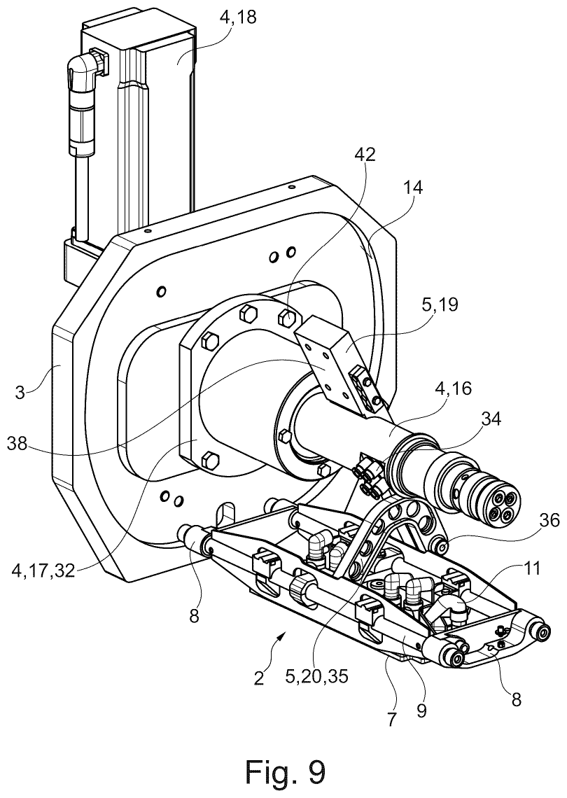

In the exemplary embodiments shown in FIGS. 1 to 7, the coupling element 20 of the lifting device 5 has two rods 21 arranged parallel to each other, which are pivotably or tiltably coupled to the transport mechanism 2 via a rotary joint connection 22. The rotary joint connection 22 enables the transport plate 7 to be guided essentially parallel to the guide contour 14 of the guide plate 3. The lift guide element 19 of the lifting device 5 is, for example, integrally formed in one piece with the drive shaft 16 and has two guide bushings 23 in which the rods 21 of the coupling element 20 are guided axially or linearly along a second direction Z. The guide bushings 23 have a length that corresponds at least to a maximum change in distance between the axis of rotation L and the transport mechanism 2 along the guide contour 14, i.e., a maximum lift length. The maximum change in distance corresponds to a difference between a smallest distance and a largest distance between the axis of rotation L and the transport mechanism 2 when the transport mechanism 2 moves along the guide contour 14. However, it is also conceivable that the guide bushings 23, and thus also the lift guide element 19, have a greater length, i.e., are longer in the second direction Z, as shown in FIG. 9. It is also conceivable that the lift guide element 19 is at least partially separate from the drive shaft 16 and is arranged on the drive shaft 16 in a rotationally and axially fixed manner, for example by means of a press fit. The guide bushings 23 are designed, for example, as sliding bushings or as roller bushings, i.e., bushings with rolling elements, in particular balls, accommodated in cages.

In FIG. 8, the lift guide element 19 of the lifting device 5 is longer in the second direction Z. Here, the lift guide element 19 is designed in three parts, whereby a middle section 24 can be designed integrally in one piece with the drive shaft 16. In such a lift guide element 19, the rods 21 of the coupling element 20 are guided along their longitudinal direction or along a lifting direction (second direction Z) over a larger section than in the embodiment shown in FIGS. 1 to 7, whereby the forces acting on the lift guide element 19, in particular on the guide bushings 23, are reduced. In addition, it is conceivable to provide a balancing mass 25 at an end of the lift guide element 19 opposite the second direction Z of the transport mechanism 2 (see FIG. 8), which serves to reduce or balance the forces and moments acting on the drive shaft 16 during rotation of the drive shaft 16 by the transport mechanism 2. This makes it possible to design the drive unit 4, in particular the drive shaft 16, smaller and thus reduce the space required for the device 1.

Since, in accordance with the embodiments described above, the lifting device 5 achieves the varying distance between the axis of rotation L and the transport mechanism 2 by means of an axial or linear guide of the coupling element 20 in the lift guide element 19, such a lifting device 5 can also be referred to as a linear lift.

As shown in FIG. 4, the drive motor 18 is coupled to the drive shaft 16 in this example via a gear and a clutch 26 so as to transmit torque. The clutch 26 is designed as a claw clutch. However, other coupling designs or other coupling elements other than the gearbox and/or the clutch 26 are also conceivable for a connection between the drive motor 18 and the drive shaft 16 so as to transmit torque. Furthermore, the drive shaft 16 has a rotary feedthrough 27, which is shown here as two separate hollow bores 28, 29. The rotary feedthrough 27 is designed to supply and/or remove a medium, in particular a fluid, such as compressed air, to and from the media guide means 11 of the transport mechanism 2. As shown in FIG. 6, the medium is fed from outside to the rotary feedthrough 27 via bores 30, 31 in the housing 17 of the drive unit 4 and/or discharged from the rotary feedthrough 27 to the outside.

In the exemplary embodiment shown in FIGS. 1 to 7, the housing 17 of the drive unit 4 is designed in two parts, wherein a first housing part 32 is arranged at an axial end of the drive shaft 16 in the first direction X, and which accommodates the clutch 26 and supports one axial end of the drive shaft 16. A second housing part 33 is arranged at another axial end of the drive shaft 16 in the first direction X and comprises the bores 30, 31, which guide the medium supplied from outside into the rotary feedthrough 27. From the rotary feedthrough 27, the medium, in particular compressed air, is conducted via conduits, e.g., hoses, channels or the like, to the media guide means 11 of the transport mechanism 2.

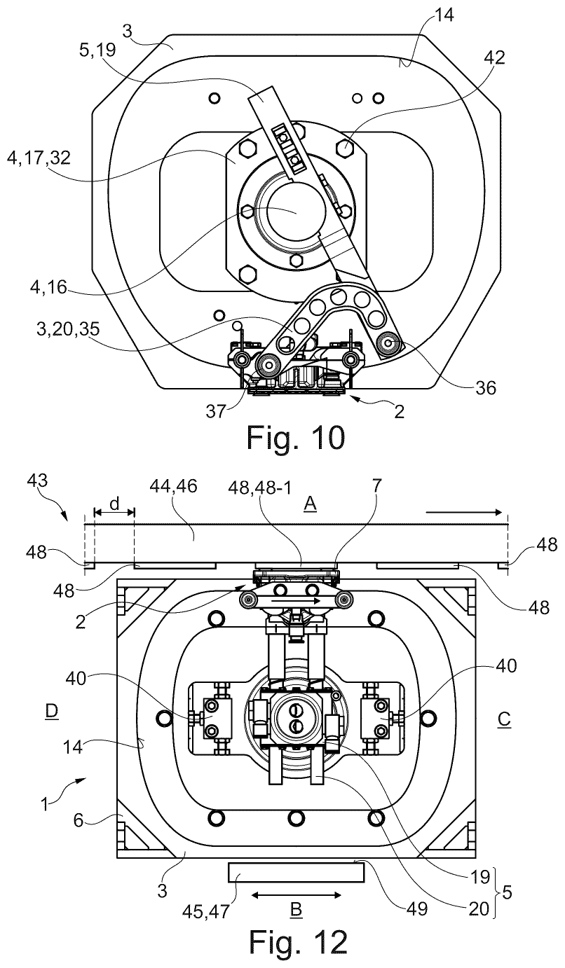

FIG. 9 and FIG. 10 show a further exemplary embodiment of the device 1 in a partial representation. The embodiment shown here differs from the embodiments described above with reference to FIGS. 1 to 8 essentially in the lifting device 5. In the embodiment shown here, the lift guide element 19 is designed to be boxlike and is coupled to the drive shaft 16 in a rotationally and axially fixed manner by means of screws 34. The coupling element 20 is designed as an articulated linkage 35, which is pivotably coupled at one end to the lift guide element 19 via a first pivot joint 36 and at the other end to the transport mechanism 2 via a second pivot joint 37 (see FIG. 10). The articulated linkage 35 has a curved shape, particularly in one plane. A longitudinal end of the lift guide element 19, which is arranged opposite the end of the lift guide element 19 coupled to the articulated linkage 35, has a receiving or mounting region 38 which is prepared and designed to receive the balancing mass 25. Furthermore, the guide plate 3 and the transport mechanism 2 also differ geometrically from the guide plate 3 and the transport mechanism 2 according to the embodiment shown in FIGS. 1 to 7. Furthermore, in the embodiment shown in FIG. 9 and FIG. 10, the drive motor 18 is rotated by 90°, i.e., it is arranged vertically instead of horizontally as shown in FIG. 1 to FIG. 6. The arrangement of the drive motor 18 relative to the rest of the device 1 can be selected depending on the available installation space and/or the arrangement of the device 1, e.g., several of these devices 1 next to each other in a system, e.g., for the manufacture of batteries and/or fuel cells.

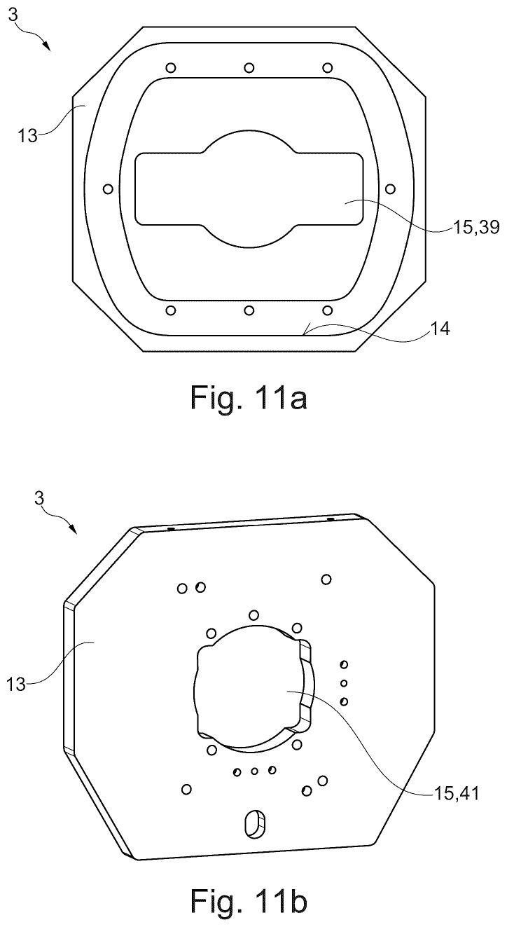

FIG. 11a and FIG. 11b show different embodiments of the guide plates 3, wherein FIG. 11a shows the guide plate 3 of the embodiment shown in FIG. 1 to FIG. 6 and FIG. 11b shows the guide plate 3 of the embodiments shown in FIG. 8 to FIG. 10. The two guide plates 3 differ essentially in the shape of the through opening 15 and the curve geometry (see also FIG. 8). The guide plate 3 shown in FIG. 11a has an elongated, rectangular-shaped through-opening 39 in which the drive shaft 16 mounted in the housing 17 is positioned via so-called push-pull elements 40 (see, for example, FIG. 1). The guide plate 3 shown in FIG. 11b has a substantially (e.g., +/−10%) round through-opening 41, which is concealed by the housing 17, in which the drive shaft 16 is mounted axially fixed but rotatably, on a side facing the transport mechanism 2. The housing 17 or the respective housing parts (FIG. 10 shows only a first housing part 32 is fastened to the guide plate 3 by means of several screws 42.

FIG. 12 shows an example of a transport unit 43 according to one embodiment of the invention. The transport unit 43 is used to transport non-rigid elements, in particular for the manufacture of a battery and/or fuel cell, and comprises the device 1 described above, a continuous system 44, and a discrete system 45. The continuous system 44 comprises, for example, a conveyor belt 46 that moves at a predetermined, in particular constant, speed. The discrete system 45 comprises, for example, one or more transport carriages 47 that move back and forth between at least two positions in a cyclical manner.

The device 1 is arranged between the continuous system 44 and the discrete system 45 in such a way that the device 1 picks up a non-rigid element 48 from the conveyor belt 46 of the continuous system 44 and places it on the transport carriage 47 of the discrete system 45. The conveyor belt 46 is designed here as a vacuum belt as an example and transports the non-rigid elements 48 on an underside by holding the non-rigid elements 48 in place on the underside by means of negative pressure or vacuum. The individual non-rigid elements 48 are arranged on the conveyor belt 46 at a distance d from each other. The distance d is selected such that when the negative pressure or vacuum on the conveyor belt 46 is reduced in the region of a non-rigid element 48 for transfer to the device 1, the adjacent non-rigid elements 48 are not affected by the reduction in negative pressure or vacuum and are therefore transported further with the conveyor belt 46. In particular, the distance d can be approximately 50-75 mm. The transport carriage 47, which acts as a place of deposit for the non-rigid element 48 transported by the device 1, can be moved in or against the direction of transport of the conveyor belt 46 (in the drawing plane), as shown in FIG. 12. In addition or alternatively, the transport carriage 47 can also be moved in the direction perpendicular to the drawing plane.

Alternatively, but not shown in the Figures, the device 1 can pick up a non-rigid element 48 from the discrete system 45 and place it on the continuous system 44.

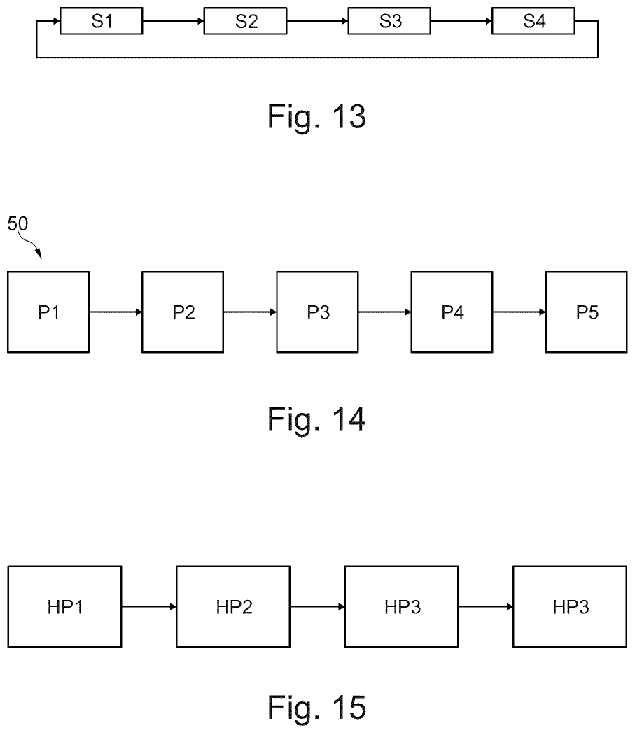

FIG. 13 shows a flow chart of an exemplary movement sequence of the device 1 for transporting non-rigid elements 48 according to one embodiment of the invention. In step S1, the transport mechanism 2 of the device 1 is located in region A (see FIG. 12) and moves parallel to the conveyor belt 46 at essentially the same speed as the conveyor belt 46 and picks up the non-rigid element 48-1 (see FIG. 12) from the conveyor belt 46 by locally reducing the negative pressure or vacuum on the conveyor belt 46 in the region of the non-rigid element 48-1 and, at approximately the same time, generating a negative pressure or vacuum on the receiving surface 10 of the transport mechanism 2. The device 1 requires approximately 50 ms for this sequence, for example. In step S2, the non-rigid element 48 is transported on the transport mechanism 2 to region B (see FIG. 12). The transition region or intermediate region located between region A and region B can also be referred to as region C. The device requires, for example, approximately 200 ms for transport from the pick-up of the non-rigid element 48 in region A to the transfer point for transferring the non-rigid element 48 in region B. In a step S3, the transport mechanism 2 transfers the non-rigid element 48 to the discrete system 45 by placing the non-rigid element 48 on the transport carriage 47. The transfer of the non-rigid element 48 from the device 1 to the transport carriage 47 takes place essentially at a standstill and, for example, analogously to the transfer of this non-rigid element 48, i.e., by reducing the negative pressure or vacuum at the receiving surface 10 of the transport mechanism 2 and, at approximately the same time, generating a negative pressure or vacuum at a surface of deposit 49 of the transport carriage 47 in order to hold the non-rigid element 48 on the surface of deposit 49. The device requires approximately 200 ms to deposit the non-rigid element 48 when stationary. In step S4, the transport mechanism 2 is moved from region B (see FIG. 12) to region A when empty, i.e., without transporting a non-rigid element 48. The region between region B and region A can also be referred to as region D, and the movement of the transport mechanism 2 from region B to region A can also be referred to as a return lift. The device 1 requires approximately 200 ms for the return lift, for example. Once it has arrived in region A, one cycle movement of the transport mechanism 2 is complete. For an entire cycle, the device 1 requires a total of approximately 650 ms according to the examples given above for the individual regions A to D.

FIG. 14 shows a flow chart of an exemplary method 50 for transporting non-rigid elements according to an exemplary embodiment. In a first step P1, the device 1 for transporting non-rigid elements 48 is provided, wherein the device 1 comprises at least the transport mechanism 2 and the drive unit 4. In a step P2, the transport mechanism 2 of the device 1 picks up the non-rigid element 48 in a first region (in FIG. 12, for example, region A). In step P3, the transport mechanism 2 of the device 1 transports the non-rigid element 48 from the first region to a second region (in FIG. 12, for example, region B). In step P4, the transport mechanism 2 of the device 1 deposits the non-rigid element 48 in the second region. In step P5, the transport mechanism 2 is moved from the second region to the first region by the drive unit 4 of the device 1.

FIG. 15 shows a flow chart of an exemplary process for manufacturing a battery cell by lamination to explain how the device 1 can be used in the manufacture of battery cells. The production of a battery cell by lamination comprises the following main processes: material feeding (HP1), production of an anode half-cell (HP2), separation of cathodes and production of mono cells (HP3), and separation of mono cells and stacking (HP4). Device 1 can be used, for example, in the main process HP4, i.e., in the separation of the mono cells and stacking. Here, device 1 can be used in particular to remove the separated mono cell, which is transported by a continuous system 44, for transport to a discrete system and for delivering the mono cell to the discrete system 45, e.g., a linear system.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCE SIGNS

1 device
2 transport mechanism
3 guide plate
4 drive unit
5 lifting device
6 assembly frame
7 transport plate
8 guide element
9 support element
10 receiving surface
11 media guide means
12 opening
13 main body
14 guide contour
15 through opening
16 drive shaft
17 housing
18 drive motor
19 lift guide element
20 coupling element
21 rod
22 rotary joint connection
23 guide bushing
24 middle section
25 balancing weight
26 clutch
27 rotary feed-through
28 hollow bore
29 hollow bore
30 bore
31 bore
32 first housing part
33 second housing part
34 screw
35 articulated linkage
36 first pivot joint
37 second pivot joint
38 mounting region
39 through opening
40 push-pull element
41 through opening
42 screw
43 transport unit
44 continuous system
45 discrete system
46 conveyor belt
47 transport carriage
48 non-rigid element
49 surface of deposit
50 method
A first region
B second region
C third region
D fourth region
d distance
L rotation axis
X first direction
Z second direction

Claimed is:

1. A device for transporting non-rigid elements for the manufacture of a battery and/or fuel cell, the device comprising:
a transport mechanism for transporting a non-rigid element from a first region to a second region;
a guide plate for guiding the transport mechanism;
a drive unit for moving the transport mechanism;
a lifting device for coupling the drive unit and the transport mechanism; and, an assembly frame,
wherein the guide plate has a plate-shaped main body, a closed guide contour provided on the plate-shaped main body, and a through-opening,
wherein the transport mechanism is guided by the guide contour,
wherein the drive unit has a drive shaft which extends in a first direction and is axially fixedly received in the through-opening of the guide plate, and
wherein the lifting device couples the transport mechanism and the drive unit to each other in a torque-transmitting manner and is configured to adjust a distance between the drive shaft and the transport mechanism in a second direction which depends on a position of the transport mechanism relative to the guide plate.

2. The device according to claim 1, wherein the transport mechanism has a transport plate and a guide element,
wherein the transport plate has a receiving surface for receiving the non-rigid element,
wherein the guide element is coupled to the transport plate in a rotationally and axially fixed manner, and
wherein the guide element of the transport mechanism is guided by the guide contour of the guide plate.

3. The device according to claim 2, wherein the guide element has at least one roller arranged to be in contact with the guide contour of the guide plate.

4. The device according to claim 2, wherein the transport mechanism further comprises a media guide means, and
wherein the receiving surface has at least one opening which is coupled to the media guide means in a fluid-conducting manner.

5. The device according to claim 1, wherein the lifting device comprises a lift guide element and a coupling element,
wherein the lift guide element is coupled to the drive shaft in a rotationally and axially fixed manner, and
wherein the coupling element is coupled at a first end in the second direction to the transport mechanism and is guided linearly in the second direction in the lift guide element at a second end in the second direction.

6. The device according to claim 1, wherein the lifting device has a lift guide element and a coupling element,
wherein the lift guide element is coupled to the drive shaft in a rotationally and axially fixed manner, and
wherein the coupling element comprises an articulated linkage coupled at a first end in the second direction to the transport mechanism and at a second end in the second direction to the lift guide element.

7. The device according to claim 1, wherein the drive unit further comprises a housing and a drive motor,
wherein the drive shaft is at least partially received in the housing and supported therein.

8. The device according to claim 1, wherein the drive shaft has a rotary feedthrough for guiding media.

9. The device according to claim 8, wherein the rotary feedthrough is coupled in a fluid-conducting manner to a media guide means of the transport mechanism in the drive shaft.

10. A transport unit for transporting non-rigid elements for the manufacture of a battery and/or fuel cell, the transport unit comprising:
a continuous system that moves continuously;
a discrete system that moves in cycles; and
the device according to claim 1,
wherein the device is arranged between the continuous system and the discrete system in such a way that the device picks up a non-rigid element from the continuous system and places the non-rigid element on the discrete system, or the device picks up a non-rigid element from the discrete system and places the non-rigid element on the continuous system.

11. A method for transporting non-rigid elements for the manufacture of a battery and/or fuel cell, the method comprising the following steps:
providing a device for transporting non-rigid elements, wherein the device has a transport mechanism and a drive unit;
picking up a non-rigid element in a first region with the transport mechanism of the device;
transporting the non-rigid element from the first region to a second region with the transport mechanism of the device;
depositing the non-rigid element in the second region with the transport mechanism of the device, and
moving the transport mechanism from the second region to the first region with the drive unit of the device.

12. The method according to claim 11, wherein the drive unit moves the transport mechanism in the first region with a first speed profile, between the first region and the second region with a second speed profile, in the second region with a third speed profile, and between the second region and the first region with a fourth speed profile.

13. The method according to claim 12, wherein the first speed profile, the second speed profile, the third speed profile, and the fourth speed profile are different from one another or at least partially identical, or
wherein at least one of the first speed profile, the second speed profile, the third speed profile and the fourth speed profile comprises a speed that is essentially zero.

14. The method according to claim 11, wherein the first region is formed as a section of a continuous system and the second region is formed as a section of a discrete system, or
wherein the first region is formed as a section of a discrete system and the second region is formed as a section of a continuous system.

15. The method according to claim 14, wherein the drive unit moves the transport mechanism in the first region with a first speed profile, between the first region and the second region with a second speed profile, in the second region with a third speed profile, and between the second region and the first region with a fourth speed profile,
wherein when the first region is formed as the section of the continuous system and the second region is formed as the section of the discrete system, the first speed profile comprises a speed that substantially corresponds to a speed of the continuous system and the third speed profile comprises a speed that is substantially zero, and
wherein when the first region is designed as the section of the discrete system and the second region is designed as the section of the continuous system, the first speed profile comprises a speed that is essentially zero and the third speed profile comprises a speed that essentially corresponds to a speed of the continuous system.
